(19) United States
(12) Patent Application Publication
(10) Pub. No.: US 2005/0050981 A1
(43) Pub. Date: Mar. 10, 2005

(54) Steering wheel and method of manufacture

(75) Inventors: Scott G. Warhover, Walled Lake, MI (US); Kurt P. Kastelic, Rochester, MI (US); Xiaoping Xu, Rochester Hills, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: Key Safety Systems, Inc.

(21) Appl. No.: 10/919,863

(22) Filed: Aug. 17, 2004

Related U.S. Application Data
(60) Provisional application No. 60/500,028, filed on Sep. 4, 2003.

(51) Int. Cl. B62D 1/04

(52) U.S. Cl. 74/552

(57) ABSTRACT

A steering wheel (20) comprising an annular rim (36), the rim including a first section (37) and a second section (39), each of the first and second sections of the rim at least partially covered by a fill material (60); a plurality of first lock features (40) provided as an integral element on the second section of the rim (36), each of the first lock features extending above a designated surface (45, 145) of the rim, the fill material (60) covering the second section of the rim (36), the fill material configured to form a cavity (72) about each first lock feature thereby providing easy access to the first lock feature and a shell (102) having an arcuately shaped body (112) and a plurality of second lock features (106) therefrom for snap engagement with a corresponding first lock feature (40).

### BACKGROUND AND SUMMARY OF THE INVENTION

This application claims the benefit of U.S. Provisional Application 60/500,028, filed on Sep. 4, 2003. The disclosure of the above application is incorporated herein by reference.

The present invention relates to steering wheels for automotive vehicles and more particularly to a steering wheel having one or more shells, each shell comprising wood, or a wood-like layer, or other decorative material or layer that is snapped onto the steering wheel armature.

It is an object of the present invention to provide a steering wheel in which each shell or other decorative material or layer is easily snapped onto a mating part of the steering wheel armature.

Accordingly the invention comprises: a steering wheel comprising an annular rim, the rim including a first section and a second section, each of the first and second sections of the rim being at least partially covered by a fill material; a plurality of first lock features is provided as an integral element on the second section of the rim, each of the first lock features extending above a designated surface of the rim, the fill material covering the second section of the rim, the fill material configured to form a cavity about each first lock feature thereby providing easy access to the first lock features, a shell having an arcuately shaped body and a plurality of second lock features extending therefrom for snap engagement with a corresponding first lock feature.

Many other objects and purposes of the invention will be clear from the following detailed description of the drawings.

### BRIEF DESCRIPTION OF THE DRAWINGS

FIG. 1 is an isometric view of a steering wheel armature incorporating the present invention.

FIG. 1a is another isometric view of the steering wheel with a decorative shell aligned with, but positioned apart from the armature.

FIG. 1b shows an alternate embodiment of the invention.

FIG. 2 is a cross-sectional view through section line 2-2 of FIG. 1.

FIG. 2a is a cross-sectional view of a lower portion of the steering wheel.

FIG. 3 is an enlargement of a portion of FIG. 1.

FIG. 3a shows a connector secured to a post.

FIG. 4 is a cross-sectional view through section 4-4 of FIG. 1.

FIG. 5 is a cross-sectional view through section 5-5 of FIG. 1.

FIG. 6 is an assembly view, in sectional form, illustrating the major components of the present invention.

FIG. 7 illustrates the interrelationship of a number of major components of the invention including a connector and a post.

FIG. 8 is an enlarged view of a connector.

FIG. 9 is a partial assembly view of the present invention.

FIG. 10 is a cross-sectional view of an assembled steering wheel.

FIG. 11 illustrates an alternate embodiment of the invention.

FIG. 12 shows another alternate embodiment.

### DETAILED DESCRIPTION OF THE DRAWINGS

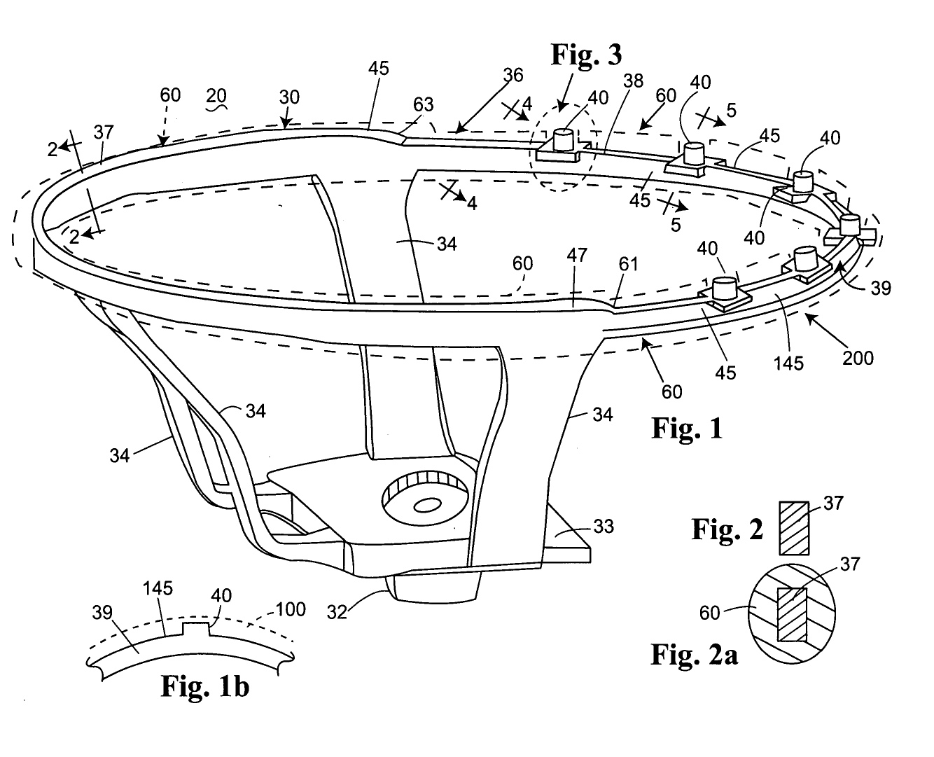

Reference is made to FIG. 1, which illustrates a steering wheel armature 30 of a steering wheel 20. As will be seen from the discussion below the armature includes a plurality of snap features 40 that are preferably formed as an integral, molded portion of the steering wheel rim 36 (which is part of the armature). Portions of the rim 36 are subsequently covered with a plastic fill material 60. One or more decorative pieces of fascia 100 are snapped upon a set of these snap features 40. In the preferred embodiment this fascia includes a wood laminate, however, other decorative materials such as carbon fiber, metal and plastic can be substituted. A leather wrap 130 (see FIG. 1a) can be used to cover the above-mentioned plastic fill material 60, as well as cover other portions of the armature, to give the steering wheel a more luxurious look and feel.

The armature 30 includes a central hub 32 connectable to a steering shaft (not shown); a hub plate 33 and a plurality of spokes 34, which connect the hub plate 33 to the rim 36. As is known in the art, the armature can be manufactured of cast aluminum or cast magnesium or from a steel stamping. Other materials and manufacturing techniques may find application in the present invention.

The steering wheel rim 36 includes a lower portion 37 as well as an integrally formed upper portion 39. With the steering wheel in a null position on the steering shaft, the steering wheel will generally be positioned in front of the driver with the lower portion 37 closer to the driver's legs and the upper position of the steering wheel oppositely oriented. The lower portion of the rim 37 has a generally oval cross-section as illustrated in FIG. 2. The upper portion 39 also has a somewhat oval cross-section and additionally includes a plurality of snap or lock features 40 distributed thereacross. In the illustrated embodiment the lock features 40 extend upwardly from the upper portion 39. The locking features 40 can be distributed uniformly across the upper portion 39 of the rim or the locking features can be concentrated in various regions forming subsets of locking features 40. As mentioned, one or more pieces of fascia 100 can be secured to the various locking features 40, which is schematically shown in FIG. 1b.

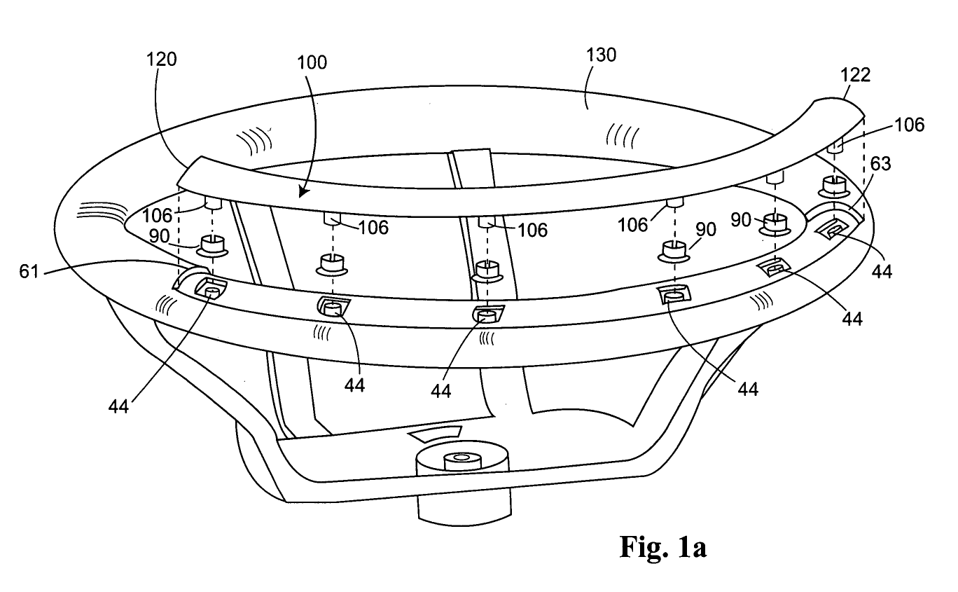

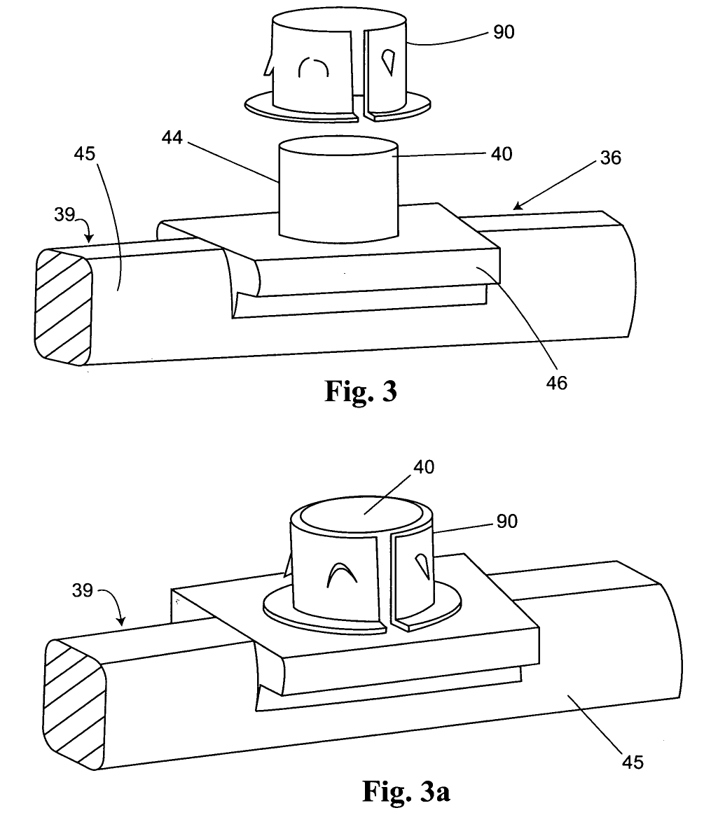

FIG. 3 is an enlargement of the upper portion 39 of the rim 36 and illustrates a typical snap feature 40. In a first embodiment of the invention, each snap feature 40 includes a post 44 cast as an integral part of the rim 36. As can be appreciated, the posts can be formed as separate structures that can be screwed, riveted or otherwise connected to the rim. In the illustrated embodiment the post 44 is solid and has a circular-cylindrical configuration, however other post configurations are within the scope of the present invention; for example the post 40 can be configured as a hollow cylindrical member. Further, the post 44 can have a rectangular or triangular hollow, cross-sectional shape. Additionally, in the preferred embodiment, the post 44 extends upwardly from a surface 45 of the rim 36.

In other embodiments the posts can be positioned on the peripheral, radial surface (see numeral 145 in FIG. 1b) and extend radially outboard from the rim 36. FIG. 1b schematically shows a piece of fascia 100 secured to the armature in this alternative configuration. Snap feature 40 optionally includes an integrally formed flange 46, which extends radially out of one or both oppositely located side surfaces 45 of the rim. As will be seen below, one of the advantages provided by flange 46 is it provides additional surface or contact area about which the fill material 60 can be over-molded to provide for a more secure attachment. Additionally, the flange provides an optional seat for a connector 90 (which is part of the snap feature 40), as discussed below. FIG. 3a shows one connector 90 seated upon a corresponding post 44.

The steering wheel 20, and more particularly rim 36, is given its conventional annular shape by insert molding a fill material 60 about the lower and upper rim portions of 37 and 39 respectively. The choice of fill material can be varied and is typically a plastic, and in some situations is chosen to provide the exterior surface of the rim of the steering wheel rather than a structure and surface that is covered by, for example, leather. The fill material 60 may be chosen from polyurethane TPEE, PVC, ABS, foam or other filler material. In those steering wheels using a trim layer such as leather, the leather is selectively mounted, bonded and sewn, in a known manner, about the fill material 60. Reference is briefly made to FIG. 2a, which shows a cross-sectional view of the lower portion 37 of the steering wheel 20, with fill material 60 molded about the lower portion 37 of the rim 36. The fill material 60 also covers the upper portion 39 of the rim 36.

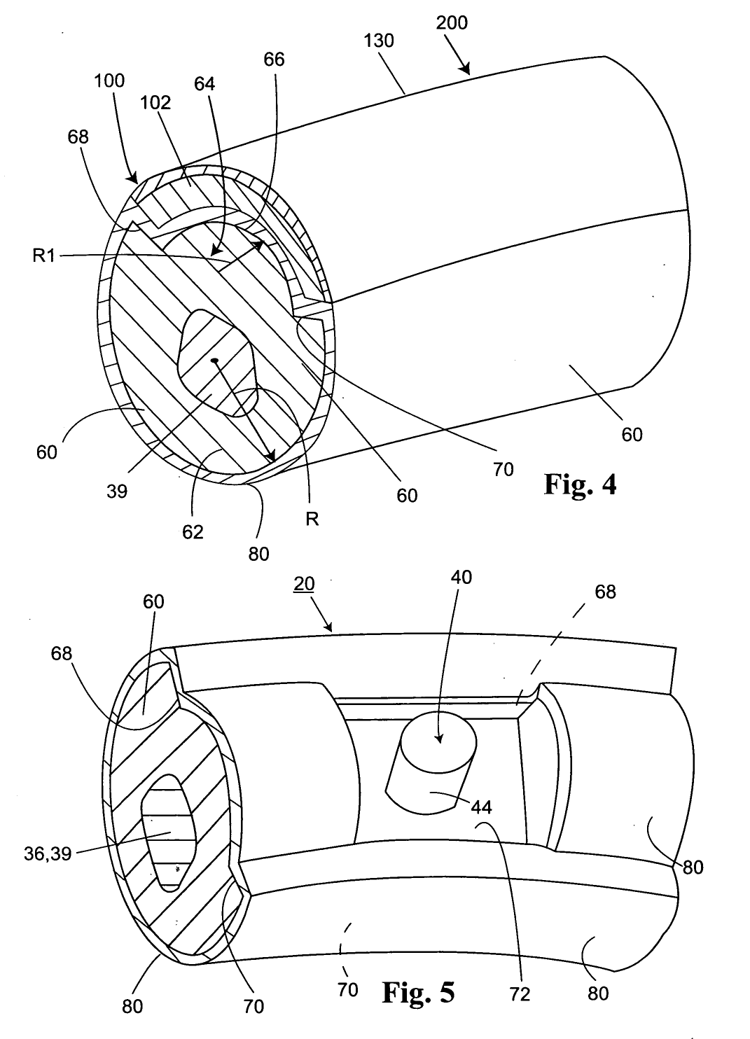

Reference is made to FIGS. 4-11, which further illustrate the construction of the upper portion of the steering wheel. The completed upper portion of the steering wheel is designated by numeral 200 as shown in FIG. 4. FIG. 4 is a cross-sectional view taken at the location of section line 4-4 in FIG. 1. It should be understood, FIG. 4 shows the fill material 60 molded about the armature while the fill material is shown in phantom line in FIG. 1. More particularly, FIG. 1 shows the fill material 60 molded about section 39 of the rim 36. The bottom or lower section 62 of the fill material 60 is arcuately shaped and of conventional design. For the purpose of discussion the lower portions 62 of the fill material (that is, the under section of the steering wheel) has a radius designated by R. The lower portion or lower surface of this part of the fill material smoothly transitions into the corresponding lower surface of the fill material applied to the lower portion 37 of the rim; this feature is generally shown in FIG. 1 where the fill material 60 is shown in phantom line about the periphery of the rim.

The upper portion 64 of the fill material 60 includes a contoured profile. For example, the center portion 66 of fill material is formed as a partial cylinder having a domed shape of radius R1. The fill material 60 adjacent each side of the center portion 66 is formed into parallel side surfaces 68 and 70, each of which is chamfered (inwardly sloped). The fill material will take the profile or be formed to have the profile as illustrated in FIG. 4. For example, the fill material in those regions of the upper portion 39 of rim 36 is remote from any of the snap features 40. Obviously, it is not desirable to envelop the posts 44 with fill material. FIG. 4 also shows an optional leather layer 80 positioned about the lower portions 64 of the fill material 60 and forming the top of the upper portion of the steering wheel. FIG. 4 also diagrammatically illustrates an exemplary fascia piece 100 (which supports a strip of leather or a strip of wood trim laminate or thin strip of natural wood all generally referred to as numeral 130). As will be shown, this fascia piece is snapped to armature 30.

FIG. 5 shows another view of the steering wheel 20. The illustrated view shows the configuration of the fill material 60 in the vicinity of and about a representative one of the snap features 40 and more particularly one of the posts 44. As can be seen, the chamfered surfaces 68 and 70 of the fill material 60 extend in a generally parallel manner on opposing sides of each post 44 forming ledges (in FIG. 5 these surfaces 68 and 70 are covered by leather layer 80, if used). The upper center portion 64 of the fill material 60, in the vicinity of each post 44, is configured to form a chamber or cavity 72 so that, in the illustrated embodiment, a connecter 90, connected to the fascia piece 100, can easily be placed about each post 44. As can be seen the chamber 72 is formed by a plurality of walls formed in the fill material generally at the location of the post 44.

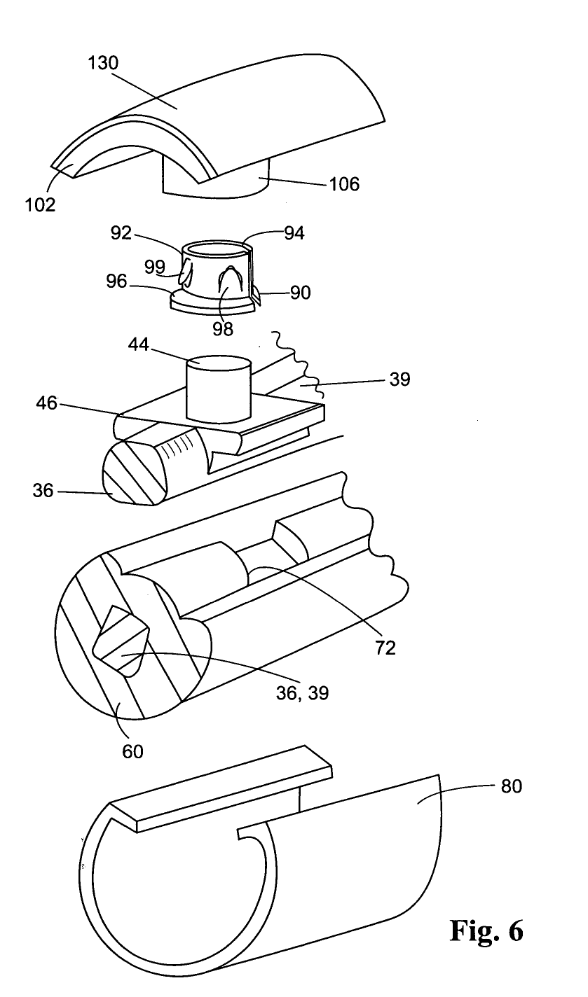

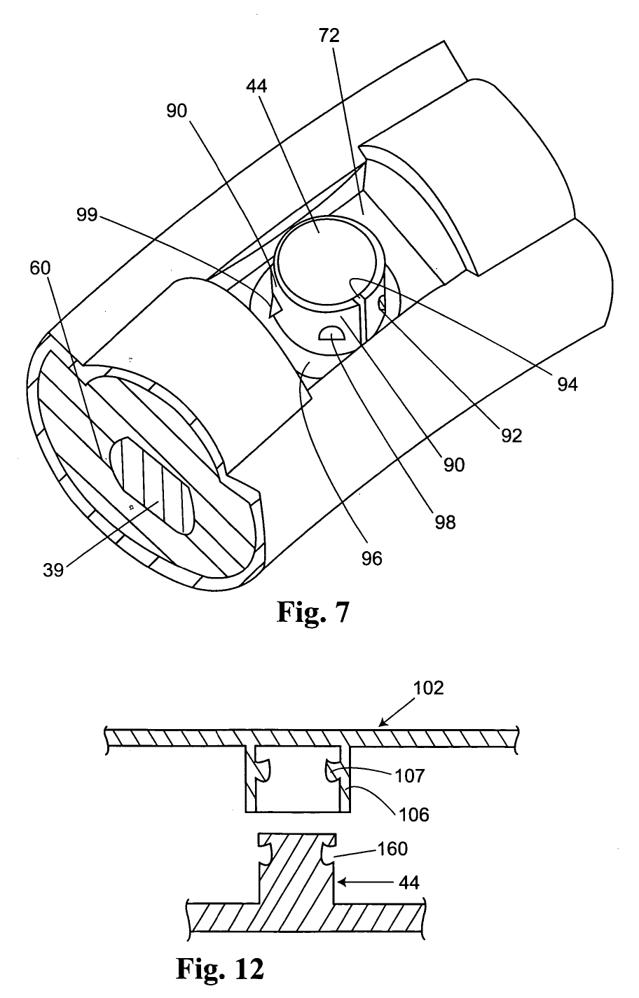

In the present embodiment each snap feature 40 comprises the post 44 as well as a separate connector 90, which is illustrated in FIGS. 6 and 7. The connector 90 is a cylindrical, metal spring with a plurality of fastening features that engage each post to hold the connector 90 in place upon a respective post 44 and to provide a snap-lock or friction lock with a mating component (see 106) of a fascia piece or shell 100. Each connector 90 includes a cylindrical body 92 with a split wall 94 to permit the wall to flex as the shell 100 is installed. The cylindrical body 92 transitions into a flat flange 96. A plurality of teeth 98 and 99 is formed on the body 92. As illustrated in FIGS. 3, 3a, 6 and 7, some of the teeth 98 are inwardly directed to engage the wall of post 44 while other teeth 99 are outwardly directed to engage a mating part of the shell.

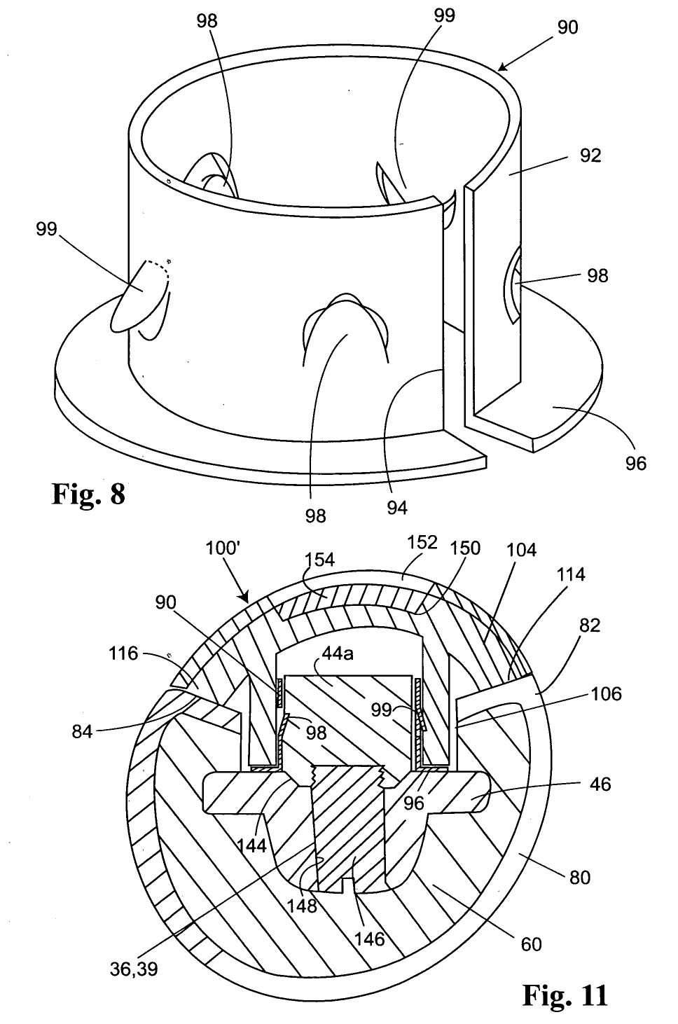

By way of clarification, while FIG. 6 has been designated as an assembly view, a portion of the fill material 60 is shown cast about the rim 36 while a part of the rim 36 with a post 44 is shown as a separate part. As can be seen, the rim is shown twice in this figure. FIG. 8 is an enlarged view of the connector 90, showing more clearly the body 92, flange 96 and the inwardly and outwardly directed clamping or locking or snap-in teeth 98 to 99 respectively. As can be appreciated, the locking or toothed features 98 and 99 of the connector 90 can be integrated into the post 44 thereby eliminating a separate connector 90.

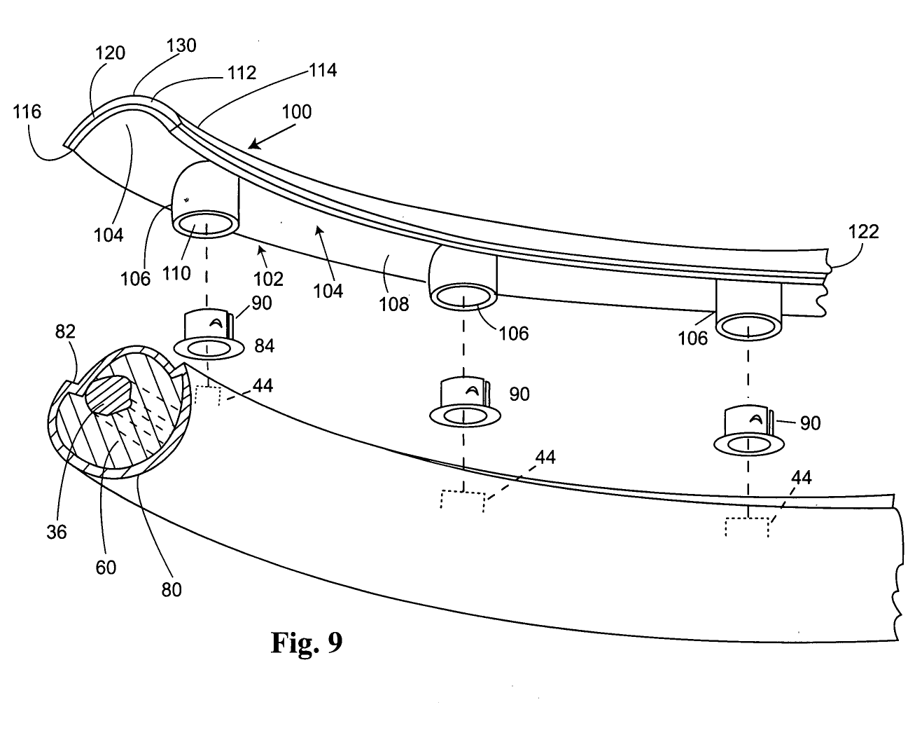

Many (less expensive) steering wheels utilize the fill material 60 as the exterior surface of the steering wheel 20. Reference is made to FIG. 9, which illustrates an elongated portion of the upper portion 39 of the rim 36, the corresponding fill material 60 (with or without a corresponding layer of leather 80) and a strip of fascia 100 positioned about this part of the steering wheel. A plurality of connectors 90 is shown spaced above this upper portion of the steering wheel 20 and below the fascia 100. Based on the above description, each connector 90 is fitted about a corresponding post 44 (in a manner illustrated in FIG. 5). FIG. 9 also illustrates a portion of the fascia 100 that is snapped or pressed upon the upper portion of the steering wheel. The fascia 100 comprises an injection-molded shell 102 having an arcuately shaped body 104 and a plurality of integrally formed hollow cylinders 106 (second lock features), which extend downward from a lower or inner or under surface 108 (which is concave in shape) of the body 104. These cylinders comprise other locking, press-on or snap-in features.

The spacing between each of the cylinders 106 corresponds to the spacing between corresponding posts 44 to permit their interconnection. The inside diameter 110 of the cylinder 106 is generally sized to tightly grip outside of the connector 90 (or the post 44 if a separate connector is not used). The top surface 112 of the shell 102 is arcuately (convex) shaped. The shell includes parallel sides 114 and 116, which are chamfered and which are conformal to the shape of the sides 68 and 70 of the fill material 60, as well as conformal to the overlapped edges 82 and 84 of the leather layer 80, if used to cover the sides 68 and 70.

The shell 102 includes opposing ends 120 and 122. When the shell 102 is snapped or pressed upon the upper portion of the steering wheel 20, the ends 120 and 122 smoothly transition into sides 61 and 63 (see FIG. 1a) formed into the molded fill material (or of the fill material covered with leather) so the top surface of the completed steering wheel is smooth and uniform, that is, the fascia smoothly transitions to the adjacent portions of the steering wheel. In the preferred embodiment, one piece of fascia 100 is used; as can be appreciated, multiple pieces of fascia can be used across various sections of the steering wheel. As mentioned, the shell 102 can be manufactured of a PVC or ABS plastic. If a wood (solid wood, wood veneer) layer or leather wrap 80, 130 is not used, the exterior or outside surface of the shell 102 or the entire wheel can be painted.

In the preferred embodiment, for example as illustrated in FIG. 9, the upper surface 112 of shell 102 is covered with a thin strip of real or simulated wood 130. Techniques for forming the wood 130 and bonding or laminating wood to plastic are known in the industry. During assembly, the shell 102 is positioned relative to the posts 44; each hollow cylinder 106 is slipped about a corresponding connector 90 (and post 44). Thereafter the shell 102 (that is the fascia 100) is seated upon the upper portion 39 of the rim, in which case the shell 102 becomes locked in place.

Reference is made to the cross-sectional view illustrated in FIG. 10, which illustrates the completed construction of the upper portion 200 of steering wheel 20. As can be seen, the chamfered sides 114 and 116 of the shell 102 are closely mated to the leather 80, which covers the chamfered sides 68 and 70 of the fill or against these sides if not covered by a covering material such as leather. The sides 114 and 116 of the shell positively load and compress the leather to provide for a functional and esthetically pleasing transition therebetween. In view of the various dimensional tolerances in the components comprising the steering wheel 20, it is preferable to leave the length of the hollow cylinder 106 slightly short so that it does not bottom upon the flange 96 or flange 46. In this way the above-mentioned chamfered surfaces will closely meet together. Additionally, the interconnection of the various teeth 98 and 99 of connector 90 can be seen in FIG. 10.

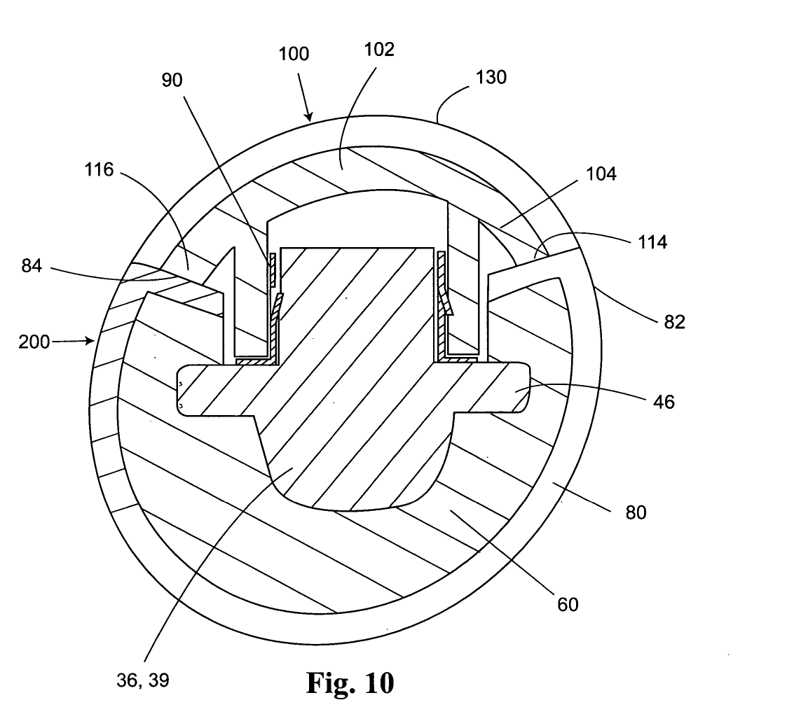

Reference is briefly made to FIG. 11, which illustrates an alternate embodiment of the invention. FIG. 11 is substantially identical to FIG. 10. The fascia 100 shown in FIG. 10 generally provides for a pleasing decorative exterior to the steering wheel. In this embodiment of FIG. 11 the fascia 100′, in addition to providing a decorative function, also provides an informational function. As illustrated, both the shell 102 and wood layers 130 include provision for an informational device; such provision may include a cutout 150. The cutout 150 is closed at its top by a clear plastic lens or layer 152. Positioned below lens or layer 152 is an informational device, generally illustrated by numeral 154. As this informational device will generally be electronic in nature, a plurality of wires (not shown) extends from device 154.

The wires are communicated to an electronic control module (not shown). For example, the device or display 154 may include one or more LEDs (light emitting diodes) which can individually and sequentially be lit to convey certain information to the driver of the vehicle. Alternatively, the LEDs might only provide decorative function to illuminate the steering wheel in one or more luminescent colors. Alternatively, the device 154 may include one or more LCDs (liquid crystal display) that can provide information to the driver, which might include information regarding the location of the vehicle, engine information, diagnostic information, news, or stock market reports. FIG. 11 also shows a further embodiment of the invention. The post 44a is formed as a separate part received within a cavity or recess 144; the post 44a is secured to the rim by a fastener such as threaded fastener 146, which is received through bore 148 in the rim.

FIG. 12 illustrates a further embodiment of the invention. In this embodiment the individual connectors 90 have been eliminated and a recess 160, such as a groove, is formed on the walls of post 44. Further, a surface of cylinder 106 is formed with an integral hook 107. When each cylinder 106, that is, the upper lock or snap feature, is mated to a corresponding post 44 (lower snap or lock feature) the integral hook 107 engages a corresponding groove 160 in a snap-together manner. The location of the recess can be in the cylinder and the hook in the post 44′.

Many changes and modifications in the above-described embodiment of the invention can, of course, be carried out without departing from the scope thereof. Accordingly, that scope is intended to be limited only by the scope of the appended claims.

1. A steering wheel (20) comprising
an annular rim (36), the rim including a first section (37) and a second section (39), each of the first and second sections of the rim at least partially covered by a fill or covering material (60);
a plurality of first lock features (40) provided as an integral element on at least the second section (39) of the rim (36), each of the first lock features extending above a designated surface (45, 145) of the rim, the fill or covering material (60) covering designated portions of the second section of the rim (36), the fill or covering material configured to form a cavity (72) about each first lock feature thereby providing easy access to the first lock features;
a shell (102) having a plurality of second lock features (106) therefrom for interlocking engagement with a corresponding first lock feature (40).

2. The steering wheel as defined in claim 1 where the shell includes an arcuately shaped body (112).

3. The steering wheel as defined in claim 1 wherein the first lock feature (40) comprises a post (44).

4. The steering wheel as defined in claim 3 wherein the second lock feature comprises a hollow cylindrical part (106) and wherein the first lock feature comprises a post (44) that fits within the cylindrical part.

5. The steering wheel as defined in claim 1 wherein the first lock feature comprises a lock mechanism 90 positioned about the post (44) which interlocks with the shell.

6. The steering wheel as defined in claim 1 wherein the shell, on an exterior surface thereof, supports a decorative layer or informational device including one of wood, a wood-like layer and an alphanumeric display (152).

7. The steering wheel as defined in claim 1 wherein the first lock feature (40) includes a post (44) extending from a designated surface of the rim and further includes at least one outwardly extending flange (46), positioned at a base of the post (44).

8 A steering wheel (20) comprising:
a rim (36) covered at least in part by a fill or covering material (60);
at least one first lock feature (40) extending from the rim from one of a top surface and a radial side surface, the fill or covering material providing a void in the vicinity of each first lock feature,
a shell (102) having at least one second lock feature (106) matingly engaging with a corresponding first lock feature.

9. The steering wheel as defined in claim 8 wherein the first lock feature includes a post integrally formed on the rim.

10. The steering wheel as defined in claim 9 wherein the post includes at least one lock tooth.

11. The steering wheel as defined in claim 10 wherein the at least one lock tooth is provided by a separate connector attached to the post.

12. The steering wheel as defined in claim 8 wherein the post is secured to the rim as a separate part.

13. A method of making a steering wheel of the type having a rim, covered with fill or covering material and a layer of fascia, comprising the steps of:
providing a rim (36);
covering at least a portion of the rim with a fill or covering material (60);
forming or providing on the rim at least one first lock feature (40) extending from the rim to one of a top surface and a radial side surface;
snapping on the at least one lock feature a shell (102) having at least one second lock feature (106) matingly engaging with a corresponding first lock feature.
